(19) United States
(12) Patent Application Publication
(10) Pub. No.: US 2007/0116466 A1
(43) Pub. Date: May 24, 2007

(54) Optical network unit (ONU) circuit

(75) Inventors: Raanan Gewirtzman, Hafia (IL); David Ivancovsky, Maccabim (IL); Moshe Levy, Tel Mond (IL); Igor Elkanovich, Tel Mond (IL); Offer Schwartsglass, Abu Gosh (IL); Simon Hochbaum, Sunnyvale, CA (US)

Correspondence Address: BROWDY AND NEIMARK, P.L.L.C.;624 NINTH STREET, NW, SUITE 300, WASHINGTON, DC, 20001-5303, US

(73) Assignee: Broadlight Ltd., Ramat Gan (IL)

(21) Appl. No.: 11/600,814

(22) Filed: Nov. 17, 2006

Related U.S. Application Data
(60) Provisional application No. 60/737,800, filed on Nov. 18, 2005.

(51) Int. Cl. H04J 14/00

(52) U.S. Cl. 398/71

(57) ABSTRACT

An optical network unit (ONU) circuit that combines both analog and digital components is provided. The ONU circuit enhances the monitoring and diagnostic of the ONU optical interface, and thus improves the overall performance of the PON. Furthermore, the disclosed ONU circuit is integrated in a single chip and thus reduces the power consumption of an ONU system and the cost to manufacture.

### CROSS REFERENCE TO RELATED APPLICATIONS

This application claims priority from a U.S. provisional application No. 60/737,800 filed on Nov. 18, 2005, whose contents are incorporated herein by reference.

### REFERENCES CITED

| | | |
|---|---|---|
| US 2002/0063924 | May 2002 | Kimbrough, et al. |
| US 2004/0202174 | October 2004 | Kim, et al. |
| US 2004/0213286 | October 2004 | Jette, et al. |
| U.S. Pat. No. 6,493,335 | December 2002 | Darcie, et al. |
| U.S. Pat. No. 6,577,414 | June 2003 | Feldman, et al. |

### FIELD OF THE INVENTION

The present invention relates generally to broadband passive optical networks (PONs), and more particularly to implementing optical network units of a PON on a single integrated circuit.

### BACKGROUND OF THE INVENTION

Interest in broadband optical access networks is growing, driven by an increasing demand for high-speed multimedia services. Optical access networks are typically referred to as fiber-to-the-curb (FTTC), fiber-to-the-building (FTTB), fiber-to-the-premise (FTTP), or fiber-to-the-home (FTTH). Each such network provides an access from a central office to a building, or a home, via optical fibers installed near or up to the subscribers' locations. As the transmission quantity of such an optical cable is much greater than the bandwidth actually required by each subscriber, a passive optical network (PON) shared between many subscribers through a splitter was developed.

An exemplary diagram of a typical PON 100 is schematically shown in FIG. 1. The PON 100 includes M optical network units (ONUs) 120-1, 120-2, through 120-M, coupled to an optical line terminal (OLT) 130 via a passive optical splitter 140. To the extent that reference is made to the ONUs without regard to a specific one thereof, such ONUs will be referenced as 120. Traffic data transmission may be achieved by using GEM fragments or ATM cells over two optical wavelengths, one for the downstream direction and another for the upstream direction. Downstream transmission from OLT 130 is broadcast to all ONUs 120. Each ONU 120 filters its respective data according to, for example, pre-assigned VPIJVCI values. ONUs 120 transmit respectivata to OLT 130 during different time slots allocated by OLT 130 for each ONU 120. Splitter 140 splits a single line into multiple lines, for example, 1 to 32, or, in case of a longer distance from OLT 130 to ONUs 120, 1 to 16.

As the demand from PONs is rapidly increasing, there is an on-going effort to reduce the costs and complexity of PON equipment. Specifically, most of development effort is focused on providing simple and low cost ONUs. Currently, the ONU is composed of major components that include a transceiver, a medium access control (MAC) adapter, a data processor and a microcontroller. The transceiver facilitates the physical layer functions and handles all the optics operations, such as conversion of optical signals to electrical signals (O/E and E/I), and optical multiplexing/de-multiplexing of the various multi-media signals serviced through the ONU. The MAC adapter handles tasks that involve processing of traffic received from or sent to the network. The data processor handles QoS and SLA related functions, including classifying, queuing, shaping and policing functions. The microcontroller executes user specific applications and other tasks related to management and control.

The main disadvantage of ONUs provided in the related industry is that there is not a single circuit that integrates these major components. As a result, the power consumption is relatively high, the life time of an ONU is short, the cost to manufacture is high, and the integration between the components is complex.

### SUMMARY OF THE INVENTION

According to a first aspect of the invention there is provided an optical network unit (ONU) circuit fabricated on a single integrated circuit (IC), the ONU circuit comprising:

a physical (PHY) layer adapter capable of interfacing with an optical interface for transmitting and receiving data at high rate;

a passive optical network (PON) processor capable of controlling the optical interface through the PHY layer adapter;

a connection connected between the PON processor and the PHY layer adapter and being capable of transferring high speed data; and

an internal bus connected between the PON processor and the PHY layer adapter and being capable of transferring, monitoring and diagnosing data.

According to a second aspect of the invention there is provided a method for controlling an optical interface coupled to an optical network unit (ONU) circuit, the method comprising:

setting the ONU circuit to calibration values of optical parameters during an initialization stage of the optical interface; and

monitoring an operation of the optical interface during an operation stage of the optical interface.

### BRIEF DESCRIPTION OF THE DRAWINGS

In order to understand the invention and to see how it may be carried out in practice, an exemplary embodiment will now be described, by way of non-limiting example only, with reference to the accompanying drawings, in which:

FIG. 1 is an exemplary diagram of a PON;

FIG. 2 is a block diagram of an ONU circuit disclosed in accordance with an embodiment of the present invention; and

FIG. 3 is a block diagram of a PHY layer adapter disclosed in accordance with an exemplary embodiment of the present invention.

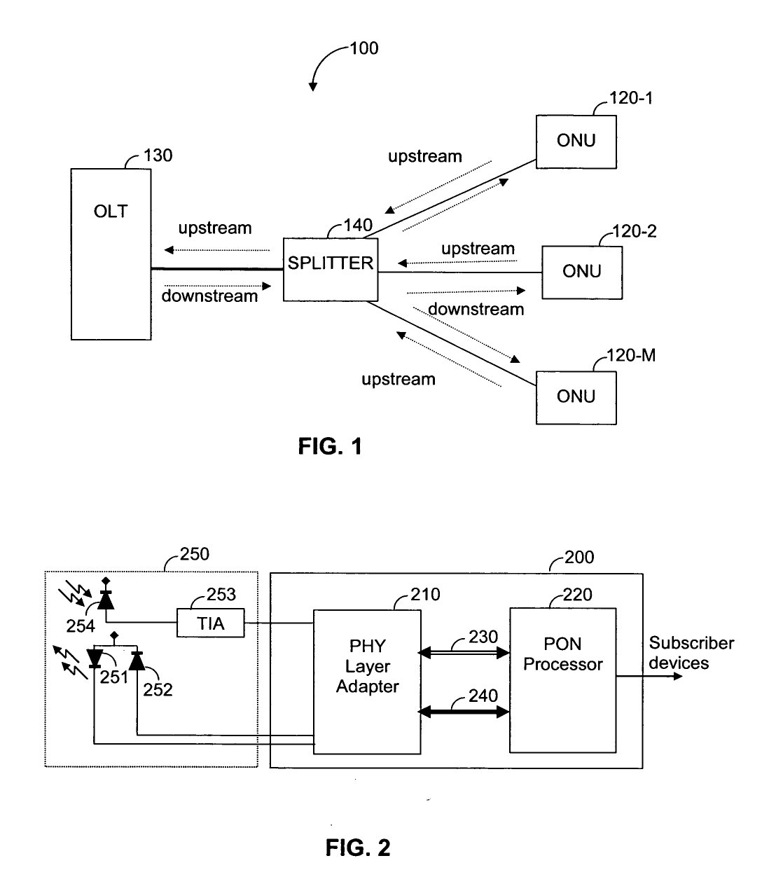

### DETAILED DESCRIPTION OF THE INVENTION

The present invention provides an ONU circuit that combines the analog and digital components. The ONU circuit enhances the monitoring and diagnostic of the ONU optical interface, and thus improves the overall performance of the PON. Furthermore, the disclosed ONU circuit is integrated in a single chip and thus reduces the power consummation of an ONU system and the cost to manufacture.

FIG. 2 shows a non-limiting and exemplary block diagram of an ONU circuit 200 disclosed in accordance with an embodiment of the present invention. The ONU circuit 200 can operate in different passive optical network (PON) modes including, but not limited to, a Gigabit PON (GPON), a Broadband PON (BPON), an Ethernet PON (EPON), or any combination thereof.

The ONU circuit 200 comprises a physical (PHY) layer adapter 210 and a PON processor 220 coupled together using a connection 230 and an inter-integrated circuit bus 240. Both the connection 230 and circuit bus 240 form an interface between the PHY layer adapter 210 and the PON processor 220. The PHY layer adapter 210 is further connected to an optical interface 250 and performs activities related to the conversion of optical signals to electrical signals and vice versa. As described in greater detail below, the PHY layer adapter 210 operates at burst mode and transmits and receives data at high rate.

The PON processor 220 is adapted to serve a plurality of PON applications. The processor 220 is a highly integrated communications processor that is capable of operating in a plurality of PON modes including, but not limited to, a GPON, a BPON, an EPON, or any combination thereof. Specifically, the processor 220 is adapted to perform processing tasks, such as bridge learning, ATM queuing and shaping, constructing of GEM frames, reassembling of packets, and so on. Data processed by the PON processor 220 may be either an upstream flow, i.e., data sent from a subscriber device to an OLT or a downstream flow, i.e., data sent from an OLT to a subscriber device. The PON processor 220 includes an Ethernet MAC adapter and a PON MAC adapter (neither of which is shown). The Ethernet MAC adapter receives and forwards Ethernet frames from and to subscriber devices connected to the ONU circuit 200. The PON MAC adapter designed to serve the needs of a multi-service ONU operating in a point to multi point optical network and to process traffic in accordance with the various PON modes.

The PON processor 220 further includes a microprocessor for supporting embedded drivers and executing PON as well as specific software applications. In accordance with one embodiment of the invention, the PON processor 220 runs a software application for calibration, initialization, and real-time monitoring, control and diagnostics of the optical interface 250. The operation of the PON processor 220 with respect to the optical interface 250 in the various operating stages is described in detail below.

By way of example, the PON processor 220 may be similar to the enhanced passive optical network (PON) processor described in co-pending U.S. application Ser. No. 11/238,022 filed Sep. 29, 2005 and entitled “An Enhanced passive optical network (PON) Processor” commonly assigned to the same assignee as the present application, and whose contents are hereby incorporated by reference. However, it will be appreciated by those skilled in the art, that an ONU circuit according to the invention may also employ a PON processor that is different from the specific processor described above. For example, the ONU circuit 200 can be integrated with a PON processor capable of operating only in a single PON mode, i.e., either in EPON, BPON, or GPON. Alternatively or collectively, the ONU circuit 200 can be designed with a PON processor that does not include an embedded processor.

The connection 230 includes a transmit line (to a laser driver) and a receive line (from a limiter amplifier) for transmitting and receiving data at high rate. The connection 230 is constructed only from passive electrical components (e.g., resistors and capacitors), thus ensuring seamless connection to the PON processor 220. The circuit bus 240 allows indication signals to be provided for monitoring and diagnostics purposes and allows the PON processor 220 to control the optical interface 250. The bus 240 is unidirectional bus configured in such way that the PON processor 220 acts as a master and the PHY adapter 210 is a slave. The bus 240 transfers indication signals related to operational parameters of the optical interface and including, but not limited to, received signal strength indication (RSSI), temperature, power supply, current driven, laser end of life (EOF), signal detected, rogue ONU and eye-safety failures, and other network control indications.

The optical interface 250 includes a laser diode 251 coupled to a photodiode 252 and a transimpedance amplifier (TIA) 253 coupled to a photodiode 254. The laser diode 251 produces optical signals based on the output signals provided by a laser diode driver. The photodiode 252 produces current in proportion to the amount of light emitted by a laser diode 251, while the photodiode 254 generates current in proportion to the amount of light of the optical input signal. The TIA 253 generates amplified voltage signal based on the current produced by photodiode 254. In accordance with one embodiment of the invention, the optical interface 250 may include another photodiode and thus support three wavelengths. Such a configuration is typically used for receiving RF signals.

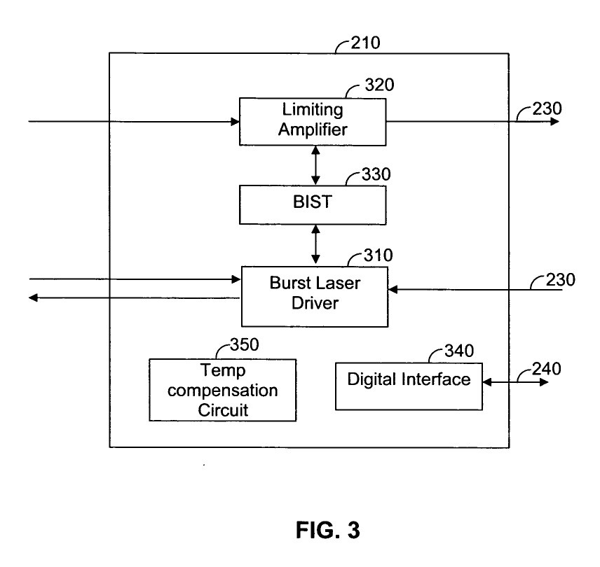

FIG. 3 shows a non-limiting diagram of the PHY layer adapter 210 disclosed in accordance with one embodiment of the present invention. The PHY layer adapter 210 includes a burst laser driver 310, continuous limiting amplifier 320, a built in self test (BIST) unit 330, a digital interface 340, and a temperature compensation circuit 350. Other accompanying circuitry and modules are not shown, merely for keeping the description simple and without limiting the scope of the disclosed invention.

The PHY layer adapter 210 can operate in at least one of GPON, EPON, and BPON ONU units. The laser driver 310 is capable of driving various types of laser diodes that include, but are not limited to, a Fabry-Perot (FP) laser, a distributed feedback (DFB) laser, and the likes. Specifically the laser driver 310 produces two current signals: bias and modulation. The bias current determines the optical power of ‘0’ levels and the modulation current determines the optical power of ‘1’ level. The laser driver 310 implements fast and slow acquisition techniques to produce accurate current signals. During fast acquisition, the laser driver 310 performs a search on its bias and modulation current sources to reach the ‘1’ and ‘0’ reference points. Once the fast acquisition is completed, the laser driver 310 is switched by the PON processor 220 to slow acquisition where for each data burst, it alternately enables ‘0’ bits and ‘1’ bits loop. When the ‘1’ bits loop is active, the modulation current source is set to a reference determined during in the acquisition period. When the ‘0’ bits loop is active, the bias current source is set. In accordance with an embodiment of the present invention, the laser driver 310 can be shutdown by eye-safety and rogue ONU failure detection circuits in the laser driver 310 (not shown). The ONU failure detection circuit alerts when the laser diode 251 always transmits data or noise. The eye-safety circuit alerts when the laser diode 251 transmits high optical power. A detailed description of the eye-safety and rogue ONU detection circuits may be found in co-pending U.S. application Ser. No. 11/514,937 filed Sep. 5, 2006 and entitled “Circuit for detecting optical failures in a passive optical network” commonly assigned to the same assignee as the present application, and whose contents are hereby incorporated by reference.

The laser driver 310 implements a dual closed-loop control to guarantee optimal optical performance over lifetime and temperature change. A detailed description of such control may be found in co-pending U.S. application Ser. No. 11/319, 776 filed Dec. 29, 2005 and entitled “Adaptive laser diode driver” commonly assigned to the same assignee as the present application, and whose contents are hereby incorporated by reference.

The limiting amplifier 320 handles downstream continuous data at high speed rates received from the OLT. The limiting amplifier 320 provides the PON processor 220 with the RSSI value and a signal detected indication which reflects the RSSI being below or above a minimum or maximum threshold value. The BIST 330 allows testing the PHY layer adapter 210 prior to ONU manufacturing. The BIST 330 tests the full data path through the limiting amplifier 320 and laser driver 310. The digital interface 340 interfaces between the circuit bus 240 and the PHY layer adapter 210. The temperature compensation circuit 350 is integrated ensures accurate performance of the optical interface 250 over all temperatures. A detailed description of the temperature compensation circuit 250 may be found in co-pending U.S. application Ser. No. 11/512,237 filed Aug. 30, 2006 and entitled “Method and circuit for providing a temperature dependent current source” commonly assigned to the same assignee as the present application, and whose contents are hereby incorporated by reference.

It will be appreciated by a person skilled in the art that by integrating the PHY layer adapter 210 and the PON processor 220 in an ONU circuit which is fabricated on a single integrated circuit (IC) provides advantages over existing ONU systems. Specifically, the ONU circuit enables the PON processor 220 to directly monitor and control the optical interface 250 through the PHY adapter layer 210. The PON processor 220 supports the optical interface 250 at the laser diode calibration, initialization, and the real-time operation stages. Consequently, there is no need for a dedicated controller, integrated with or external to the optical interface 250. Furthermore, by providing the ONU circuit as disclosed by the present invention the manufacturing and maintenance costs of ONUs are significantly reduced. The integration opens a rich interface between the PON processor 240 and the optical interface 250, further enables advanced monitoring of the optical interface beyond what is currently available by standard solutions. As a non-limiting example, the integration provides historical storage of the behavior of the optical interface 250 for off-line analysis and maintenance planning.

In an embodiment the ONU circuit 200 is fabricated on a die using complementary metal oxide semiconductor (CMOS) technology. In accordance with another embodiment of the ONU's circuit 200, components can be independently fabricated using different technologies, and then packaged in a single chip.

As mentioned above the ONU circuit 200 supports the calibration, initialization and operation stages of the optical interface 250. In the calibration stage the optical interface 250 is calibrated to the required optical parameters during manufacturing. The calibration is performed without connecting external testing and calibration equipments to the PHY layer adapter 210, but rather by a software application that runs over the PON processor 220. In the calibration stage, the PON processor 220 calculates the bias and modulation currents for different power levels, bias and modulation currents for different temperatures, a RSSI reference value for a signal detected threshold, eye-safety parameters (i.e., maximum bias and modulation currents), and threshold values for at least temperature, power supplies, RSSI, and EOL indications. All calculated data is stored in a non-volatile memory.

The initialization stage is the first operational mode of an ONU in normal operation with respect to the optical interface 250. This stage takes place after power-up or hardware reset. In the initialization stage the PON processor 220 reads calibration data stored in the non-volatile memory and sets the modules of PHY layer adapter 210 accordingly, thereby allowing the proper operation of the optical interface 250. That is, the PON processor 220 sets the bias and modulation currents according to the local temperature and the desired output power level as well as the various indications thresholds.

Once the initialization stage is completed, the PON processor 220 starts to periodically monitor the indication signals reported by the PHY adapter layer via the circuit bus 240 and to generate alarms if one or more of the signals do not meet the indication thresholds. The PON processor 210 raises at least the following alarms: temperature, power supply, signal detected, RSSI, laser EOL, eye-safety, and rogue ONU. A temperature alarm is triggered if the local temperature does not meet the temperature indication threshold. The PON processor 220 reads the local temperature through the PHY adapter 210. A power supply alarm is generated if at least one of the power supplies of the PHY layer adapter 210 is above or below the power supply indication threshold. A signal detected alarm is generated if the PHY layer interface 210 reports that the RSSI is below or above a minimum or maximum threshold value. To generate a RSSI alarm the PON processor reads the RSSI value compares it with the preceding RSSI value. If the difference between the two values is above a predefined threshold value the RSSI alarm is triggered. The PON processor 220 monitors the laser bias and modulation currents, compares them to an EOL indication threshold, and generates a laser EOL alarm if the currents values do not meet the predefined EOL threshold. The eye-safety and rogue ONU alarms are generated if the PHY layer adapter 210 reports on these failures.

It will be understood that the PON processor 220 according to the invention may be implemented in hardware or software. Thus, the invention contemplates a machine-readable program being readable by a computer or equivalent device for executing the method of the invention. The invention further contemplates a machine-readable memory tangibly embodying a program of instructions executable by the machine for executing the method of the invention.

1. An optical network unit (ONU) circuit fabricated on a single integrated circuit (IC), the ONU circuit comprising:
a physical (PHY) layer adapter capable of interfacing with an optical interface for transmitting and receiving data at high rate;
a passive optical network (PON) processor capable of controlling the optical interface through the PHY layer adapter;
a connection connected between the PON processor and the PHY layer adapter and being capable of transferring high speed data; and
an internal bus connected between the PON processor and the PHY layer adapter and being capable of transferring, monitoring and diagnosing data.

2. The ONU of claim 1, wherein the PHY layer adapter comprises:
a burst laser driver for driving a laser diode and for handling high speed upstream data;
a continuous limiting amplifier for handling high speed downstream data; and
a digital interface for interfacing with the internal bus.

3. The ONU circuit of claim 2, wherein the PHY layer adapter further comprises:
a built in self test (BIST) unit for testing the PHY layer adapter; and
a temperature compensation circuit for ensuring accurate performance of the optical interface over a wide range of temperatures.

4. The ONU circuit of claim 2, wherein the laser driver generates at least a bias current signal and a modulation current signal.

5. The ONU circuit of claim 3, wherein the laser driver is a Fabry-Perot (FP) laser or a distributed feedback (DFB) laser.

6. The ONU circuit of claim 2, wherein the optical interface is coupled to the PHY layer adapter and comprises a first photodiode coupled to a laser diode and a second photodiode coupled to a transimpedance amplifier (TIA).

7. The ONU circuit of claim 1, wherein the PON processor comprises:
a microprocessor adapted to control at least one of: a calibration stage, an initialization stage, and an operation stage of the optical interface.

8. The ONU circuit of claim 7, wherein when controlling the calibration stage the microprocessor is adapted to:
calculate values of a plurality of optical parameters; and
save calculated values of the optical parameters in a memory.

9. The ONU circuit of claim 8, wherein the optical parameters include at least one of: bias and modulation currents for different power levels, bias and modulation currents for different temperatures, a signal strength indication (RSSI), power supply thresholds, a laser end of life (EOL) threshold, and eye-safety reference values.

10. The ONU circuit of claim 8, wherein when controlling the initialization stage the microprocessor is adapted to:
read the calculated values of the optical parameters; and
set the PHY layer adapter according to the calculated values of the optical parameters.

11. The ONU circuit of claim 8, wherein when controlling the operation stage the microprocessor is adapted to:
periodically receive diagnostic data from the PHY layer interface; and
generate a plurality of network control alarms using the diagnostic data and the calculated values of the optical parameters.

12. The ONU circuit of claim 11, wherein the plurality of network control alarms comprises at least one of: a temperature alarm, a power supplies alarm, a signal detected alarm, a laser EOL alarm, an eye-safety alarm, a rogue ONU alarm.

13. The ONU circuit of claim 11, wherein the diagnostic data includes at least one of: a local temperature, voltage values of power supplies, a RSSI value, a bias current value, a modulation current value, an eye-safety indication, a rogue ONU indication.

14. The ONU circuit of claim 7, wherein the PON processor further comprises a PON MAC adapter and Ethernet MAC adapter for processing PON traffic.

15. The ONU circuit of claim 1, wherein the connection includes at least:
a transmit line for transmitting high speed upstream data; and
a receive line for receiving high speed downstream data.

16. The ONU circuit of claim 15, being adapted to operate in at least one of: a Gigabit PON (GPON) mode, a Broadband PON (BPON) mode, and an Ethernet PON (EPON) mode.

17. The ONU circuit of claim 1, being fabricated using complementary metal oxide semiconductor (CMOS) technology.

18. The ONU circuit of claim 1, wherein the PHY layer adapter and the PON processor are independently fabricated and then packaged in a single chip.

19. A method for controlling an optical interface coupled to an optical network unit (ONU) circuit, the method comprising:
setting the ONU circuit to calibration values of optical parameters during an initialization stage of the optical interface; and
monitoring an operation of the optical interface during an operation stage of the optical interface.

20. The method of claim 19, wherein the optical parameters include at least one of: bias and modulation current for different power levels, bias and modulation current for different temperatures, a signal strength indication (RSSI), a power supplies threshold, a laser end of life (EOL) threshold, eye-safety reference values.

21. The method of claim of 19, including calculating the calibration values and saving the calibration values in a memory.

22. The method of claim 21, further comprising reading the calibration values from the memory prior to setting the calibration values.

23. The method of claim 22, wherein monitoring the operation of the optical interface further comprises:
periodically sensing diagnostic data; and
generating a plurality of network control alarms using the diagnostic data and the calibration values.

24. The method of claim 23, wherein the plurality of network control alarms comprise at least one of: a temperature alarm, a power supplies alarm, a signal detected alarm, laser EOL alarm, an eye-safety alarm, a rogue ONU alarm.

25. The method of claim 23, wherein the diagnostic data includes at least one of: a local temperature, voltage values of power supplies, a RSSI value, a bias current value, a modulation current value, an eye-safety indication, a rogue ONU indication.

26. A program storage device readable by machine, tangibly embodying a program of instructions executable by the machine to perform a method for controlling an optical interface coupled to an optical network unit (ONU) circuit, the method comprising:
setting the ONU circuit to calibration values of optical parameters during an initialization stage of the optical interface; and
monitoring an operation of the optical interface during an operation stage of the optical interface.

27. The program storage device of claim 26, wherein the optical parameters include at least one of: bias and modulation current for different power levels, bias and modulation current for different temperatures, a signal strength indication (RSSI), a power supplies threshold, a laser end of life (EOL) threshold, eye-safety reference values.

28. The program storage device of claim of 27, wherein the method includes calculating the calibration values and saving the calibration values in a memory.

29. The program storage device of claim 28, wherein the method further includes reading the calibration values from the memory prior to setting the calibration values.

30. The program storage device of claim 29, wherein monitoring the operation of the optical interface further includes:
periodically sensing diagnostic data; and
generating a plurality of network control alarms using the diagnostic data and the calibration values.

31. The program storage device of claim 30, wherein the plurality of network control alarms comprise at least one of: a temperature alarm, a power supplies alarm, a signal detected alarm, laser EOL alarm, an eye-safety alarm, a rogue ONU alarm.

32. The program storage device of claim 30, wherein the diagnostic data includes at least one of: a local temperature, voltage values of power supplies, a RSSI value, a bias current value, a modulation current value, an eye-safety indication, a rogue ONU indication.
